(19) United States
(12) Patent Application Publication
(10) Pub. No.: US 2025/0042338 A1
(43) Pub. Date: Feb. 6, 2025

(54) VEHICLE ROOF RACK WITH LIGHT ASSEMBLY

(71) Applicant: EVERMORE INTERNATIONAL GROUP CO., LTD., GEORGE HILL (AI)

(72) Inventor: Wade CHI, Taipei City (TW)

(21) Appl. No.: 18/479,895

(22) Filed: Oct. 3, 2023

(30) Foreign Application Priority Data
Aug. 3, 2023 (TW) 112208201

(51) Int. Cl. B60R 9/04; B60Q 1/24

(52) U.S. Cl. CPC B60R 9/04; B60Q 1/247

(57) ABSTRACT

A vehicle roof rack with a light assembly includes a main body, the light assembly, at least one first shielding member and at least one second shielding member. The main body includes at least one recession. The light assembly includes at least one light-emitting member disposed within the at least one recession. The at least one first shielding member is disposed on the main body and corresponds to the at least one light-emitting member. The at least one second shielding member is disposed on the main body and corresponds to the at least one first shielding member. At least a portion of light emitted from the at least one light-emitting member is projected outward through the at least one first shielding member and the at least one second shielding member.

### BACKGROUND OF THE INVENTION

### Field of the Invention

The present invention relates to a vehicle roof rack with a light assembly.

### Description of the Prior Art

A vehicle roof rack, such as a roof tray, a luggage rack, etc., is configured to be assembled to a roof of a vehicle for carrying objects so as to provide a large capacity without occupying the space inside the vehicle and be convenient to use. The conventional vehicle roof rack has a single function and is inconvenient to use in a dark environment. Therefore, a vehicle roof rack with a lighting device is developed.

However, the lighting device is directly assembled to the existing vehicle roof rack so that the lighting device relatively protrudes out of the vehicle roof rack, which is easy to be damaged by collision, inconvenient to be assembled and has poor appearance. In addition, the lighting device is easy to be damaged due to rain or moisture.

The present invention is, therefore, arisen to obviate or at least mitigate the above-mentioned disadvantages.

### SUMMARY OF THE INVENTION

The main object of the present invention is to provide a vehicle roof rack with a light assembly, which is waterproof and provides good lighting effect.

To achieve the above and other objects, the present invention provides a vehicle roof rack with a light assembly, configured to be attached to a roof of a vehicle, including: a main body, the light assembly, at least one first shielding member and at least one second shielding member. The main body includes at least one recession. The light assembly includes at least one light-emitting member disposed within the at least one recession. The at least one first shielding member is disposed on the main body and corresponds to the at least one light-emitting member. The at least one second shielding member is disposed on the main body and corresponds to the at least one first shielding member. At least a portion of light emitted from the at least one light-emitting member is projected outward through the at least one first shielding member and the at least one second shielding member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial breakdown drawing of a preferable embodiment of the present invention;

FIG. 3 is a partial enlargement of a preferable embodiment of the present invention; and

FIG. 4 is a cross sectional view of a preferable embodiment of the present invention.

### DETAILED DESCRIPTION OF THE PREFERRED EMBODIMENTS

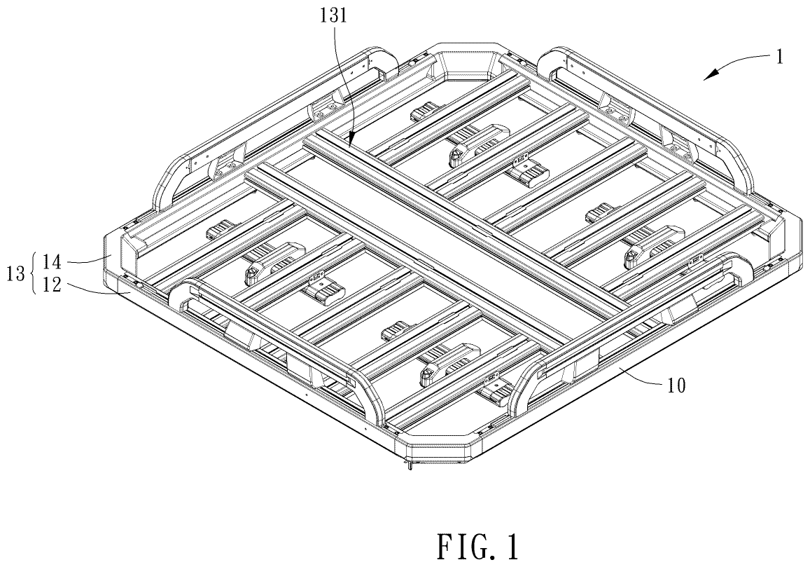

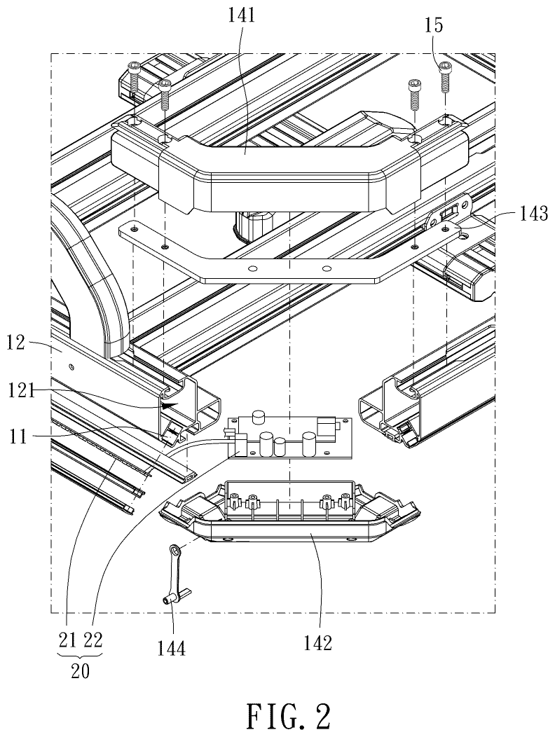

Please refer to FIGS. 1 to 4 for a preferable embodiment of the present invention. A vehicle roof rack 1 with a light assembly 20 of the present invention is configured to be attached to a roof of a vehicle and includes a main body 10, the light assembly 20, at least one first shielding member 30 and at least one second shielding member 40.

The main body 10 includes at least one recession 11. The light assembly 20 includes at least one light-emitting member 21 disposed on the at least one recession 11. The at least one first shielding member 30 is disposed on the main body 10 and corresponds to the at least one light-emitting member 21. The at least one second shielding member 40 is disposed on the main body 10 and corresponds to the at least one first shielding member 30. At least a portion of light emitted from the at least one light-emitting member 21 is projected outward through the at least one first shielding member 30 and the at least one second shielding member 40, which provides soft light and good lighting effect and prevents the at least one light-emitting member 21 from moisture.

The main body 10 includes a plurality of rod members 12, the plurality of rod members 12 are connected with one another to form a frame 13, and each of the at least one recession 11 is disposed on one of the plurality of rod members 12. In this embodiment, each of the at least one recession 11 extends in a longitudinal direction of one of the plurality of rod members 12 and is open outward in a direction lateral to the longitudinal direction. Each of the at least one second shielding member 40 covers an opening of one of the at least one recession 11 so as to avoid moisture and provide uniform lighting effect. Preferably, each of the at least one recession 11 is disposed on an outer circumferential surface of the frame 13 and is open downward in a direction remote from a loading surface 131 of the frame 13. Therefore, water is not easy to flow into the at least one recession 11, which effectively prevents the at least one light-emitting member 21 from moisture.

Moreover, the main body 10 further includes a plurality of connecting portions 14, and the plurality of connecting portions 14 are detachably connected with the plurality of rod members 12. The light assembly 20 further includes at least one control unit 22 electrically connected with the at least one light-emitting member 21. Each of the at least one light-emitting member 21 is disposed on one of the plurality of rod members 12, and each of the at least one control unit 22 is disposed on one of the plurality of connecting portions 14, which is easy to be assembled and maintenance. Each said control unit 22 may control one said light-emitting member 21 or a plurality of said light-emitting members 21, and the light assembly 20 may be powered by at least one of a battery, a solar cell, an electrical interface (such as USB ports, DC ports, etc.) and a vehicle power. In this embodiment, each of the at least one light-emitting member 21 is a LED strip, and a length of each of the at least one first shielding member 30 and a length of each of the at least one second shielding member 40 are longer than or equal to a length of one of the at least one light-emitting member 21. One said light-emitting member 21, one said first shielding member 30 and one said second shielding member 40 are assembled to one of the plurality of rod members 12 through an end opening of one said recession 11 in the longitudinal direction, which has a simple structure and is easy to be assembled. In other embodiments, each said recession may receive a plurality of said light-emitting members, a plurality of said first shielding members and a plurality of said second shielding members, which is separately detachable and is easy to maintenance.

Each of the plurality of connecting portions 14 includes an upper cover 141, a lower cover 142 and a reinforcing member 143 disposed between the upper cover 141 and the lower cover 142. Each of the plurality of rod members 12 includes a hollow portion 121, and two ends of each said reinforcing member 143 respectively penetrate into the hollow portion 121 of one of the plurality of rod members 12. One of said reinforcing member 143, one of the plurality of rod members 12 and at least one of the upper cover 141 and the lower cover 142 are connected with one another by a plurality of fasteners 15. The upper cover 141 and the lower cover 142 may be made of plastic material, and the reinforcing member 143 may be a metal plate, which is convenient to assemble and maintain the at least one control unit 22, and provides good structural strength. At least one of the plurality of connecting portions 14 may have a plug 144 disposed thereon, and the plug 144 is configured to cover the electrical interface to achieve waterproof and dustproof effects.

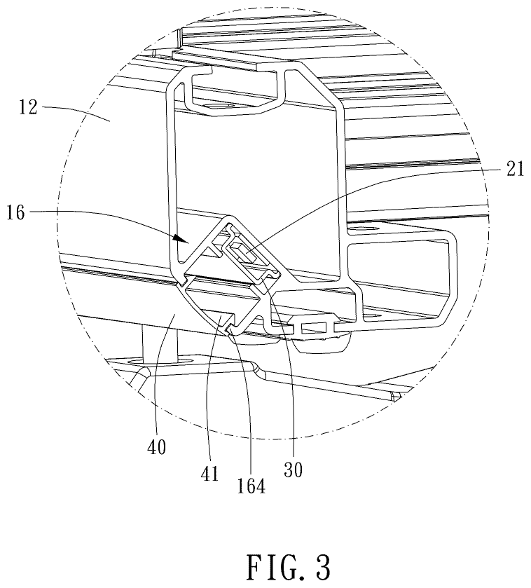

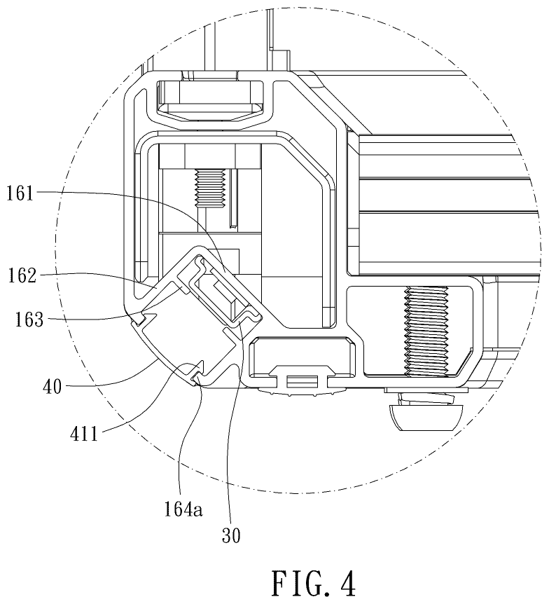

Specifically, the main body 10 further includes at least one assembling portion 16, and each of the at least one assembling portion 16 includes a bottom wall 161 and two side walls 162 which define one of the at least one recession 11. At least one of the two side walls 162 has at least one blocking projection 163, and the bottom wall 161 and the at least one blocking projection 16 have one of the at least one first shielding member 30 disposed therebeween, as shown in FIGS. 3 and 4. Therefore, the at least one first shielding member 30 is positioned without additional fixing or adhering. A side of at least one of the two side walls 162 of the at least one assembling portion 16 remote from the bottom wall 161 has a first engaging portion 164 disposed thereon, and each of the second shielding member 40 has a second engaging portion 41 engaged within one said first engaging portion 164, which is easy to be assembled. In this embodiment, the two side walls 162 of each said assembling portion 16 has two said blocking projections 163 extending toward each other; each said first engaging portion 164 includes two flanges 164a extending from the two side walls 162 toward each other, and each said second engaging portion 41 includes two legs 411 spacedly corresponding to each other. Therefore, the two legs 411 are engaged with the two flanges 164a so as to have good assembling stability and provide dustproof and waterproof effects. Preferably, a distance between each said blocking projection 163 and one said bottom wall 161 is shorter than or equal to a distance between each said blocking projection 163 and one said first engaging portion 164; a distance between the two said blocking projections 163 facing each other is smaller than a width of an opening of one of the at least one recession 11 so as to effectively restrict each said first shielding member 30 and achieve light guiding effect.

A light transmittance of the at least one first shielding member 30 is higher than or equal to a light transmittance of the at least one second shielding member 40, which allows the light to be projected outward. The at least one first shielding member 30 and the at least one second shielding member 40 may be light guide boards made of plastic, which is light and waterproof and is easy to manufacture.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle roof rack with a light assembly, configured to be attached to a roof of a vehicle, including:
a main body, including at least one recession;
the light assembly, including at least one light-emitting member disposed within the at least one recession;
at least one first shielding member, disposed on the main body and corresponding to the at least one light-emitting member; and
at least one second shielding member, disposed on the main body and corresponding to the at least one first shielding member;
wherein at least a portion of light emitted from the at least one light-emitting member is projected outward through the at least one first shielding member and the at least one second shielding member.

2. The vehicle roof rack with the light assembly of claim 1, wherein the main body include a plurality of rod members, the plurality of rod members are connected with one another to form a frame, and each of the at least one recession is disposed on one of the plurality of rod members.

3. The vehicle roof rack with the light assembly of claim 2, wherein each of the at least one recession extends in a longitudinal direction of one of the plurality of rod members and is open outward in a direction lateral to the longitudinal direction, and each of the at least one second shielding member covers an opening of one of the at least one recession.

4. The vehicle roof rack with the light assembly of claim 1, wherein each of the at least one light-emitting member is a LED strip, and a length of each of the at least one first shielding member and a length of each of the at least one second shielding member are longer than or equal to a length of one of the at least one light-emitting member.

5. The vehicle roof rack with the light assembly of claim 1, wherein a light transmittance of the at least one first shielding member is higher than or equal to a light transmittance of the at least one second shielding member.

6. The vehicle roof rack with the light assembly of claim 1, wherein the main body further includes a plurality of rod members and a plurality of connecting portions, the plurality of connecting portions are detachably connected with the plurality of rod members, the light assembly further includes at least one control unit electrically connected with the at least one light-emitting member, each of the at least one light-emitting member is disposed on one of the plurality of rod members, and each of the at least one control unit is disposed on one of the plurality of connecting portions.

7. The vehicle roof rack with the light assembly of claim 1, wherein the main body further includes at least one assembling portion, each of the at least one assembling portion includes a bottom wall and two side walls which define one of the at least one recession, at least one of the two side walls has at least one blocking projection, and the bottom wall and the at least one blocking projection have one of the at least one first shielding member disposed therebeween.

8. The vehicle roof rack with the light assembly of claim 7, wherein a side of at least one of the two side walls of each of the plurality of assembling portion remote from the bottom wall has a first engaging portion disposed thereon, and each of the at least one second shielding member has a second engaging portion engaged within one said first engaging portion.

9. The vehicle roof rack with the light assembly of claim 8, wherein a distance between each said blocking projection and one said bottom wall is shorter than or equal to a distance between each said blocking projection and one said first engaging portion.

10. The vehicle roof rack with the light assembly of claim 3, wherein each of the at least one light-emitting member is a LED strip, and a length of each of the at least one first shielding member and a length of each of the at least one second shielding member are longer than or equal to a length of one of the at least one light-emitting member; a light transmittance of the at least one first shielding member is higher than or equal to a light transmittance of the at least one second shielding member; the main body further includes a plurality of connecting portions, the plurality of connecting portions are detachably connected with the plurality of rod members, the light assembly further includes at least one control unit electrically connected with the at least one light-emitting member, each of the at least one light-emitting member is disposed on one of the plurality of rod members, and each of the at least one control unit is disposed on one of the plurality of connecting portions; each of the plurality of connecting portions includes an upper cover, a lower cover and a reinforcing member disposed between the upper cover and the lower cover, each of the plurality of rod members includes a hollow portion, two ends of each said reinforcing member respectively penetrate into the hollow portion of one of the plurality of rod members, and one of said reinforcing member, one of the plurality of rod members and at least one of the upper cover and the lower cover are connected with one another by a plurality of fasteners; the main body further includes at least one assembling portion, each of the at least one assembling portion includes a bottom wall and two side walls which define one of the at least one recession, the two side walls have two blocking projections extending toward each other, and the bottom wall and the two blocking projections have one of the at least one first shielding member disposed therebeween; a distance between the two blocking projections facing each other is smaller than a width of an opening of one of the at least one recession; a side of at least one of the two side walls of each of the at least one assembling portion remote from the bottom wall has a first engaging portion disposed thereon, and each of the at least one second shielding member has a second engaging portion engaged within one said first engaging portion; a distance between each said blocking projection and one said bottom wall is shorter than or equal to a distance between each said blocking projection and one said first engaging portion; each of the at least one recession is disposed on an outer circumferential surface of the frame and is open downward in a direction remote from a loading surface of the frame; and each said first engaging portion includes two flanges extending from the two side walls toward each other, and each said second engaging portion includes two legs spacedly corresponding to each other.
